(19) United States
(12) Patent Application Publication
(10) Pub. No.: US 2026/0120106 A1
(43) Pub. Date: Apr. 30, 2026

(54) CONTEXT DRIVEN GENERATIVE ARTIFICIAL INTELLIGENCE (AI) BASED SYSTEM AND METHOD

(71) Applicant: MASTERCARD INTERNATIONAL INCORPORATED, Purchase, NY (US)

(72) Inventors: Deepak Bhatt, O'Fallon, MO (US); Christopher John Merz, Wildwood, MO (US); Joshua A. Allbright, Chesterfield, MO (US)

(21) Appl. No.: 18/932,337

(22) Filed: Oct. 30, 2024

(51) Int. Cl. G06Q 20/40; G06F 40/205

(52) U.S. Cl. CPC G06Q 20/4016; G06F 40/205

(57) ABSTRACT

A graphical modeling computer system configured to: (i) generate a graphical model including each payment node of a plurality of payment nodes, each funding node of a plurality of funding nodes, and a transaction edge between the payment nodes and funding nodes representing transactions; (ii) retrieve personally identifiable information (PII) for each transaction; (iii) train the graphical model to include PII embeddings; (iv) convert the graphical model into natural language sentences describing each transaction and the associated PII embeddings; (v) generate, using the GAI tools, n-dimensional vector embeddings, including the associated PII, for the transactional edge; (vi) build and train a final graphical model including approved transactions and n-dimensional vector embeddings to apply the final graphical model to a subsequent transaction between a payment node and a funding node to determine if the subsequent transaction is a fraudulent transaction.

### BACKGROUND

The field of the disclosure relates generally to systems and methods for using generative artificial intelligence to detect anomalous data, and, more particularly, to network-based systems and methods that use context driven generative AI modeling and graphical analytics to detect anomalous data patterns.

It is common for computer systems to transmit data messages over a computer network. In some cases, the computer devices sending such data messages may be referred to as computer nodes. In other words, a first computer node may send a message over a computer network to a second computer node. The second computer mode may receive that message, process it, and respond back to the first computer node with additional or different data. In these cases, it may be important for the second computer node, before responding to the first computer node, to be sure that the first node is legitimate and authorized to receive the data from the second computer node. Thus, the second computer node may need to authenticate the first computer node before responding to the first node. This authentication may be performed in many different ways. For example, the first computer node may have to provide some identifying data to the first computer node before the second computer node responds back to it.

One example of computer nodes communicating with one another in today's high-tech world is in the area of processing payment transactions. These transactions may be performed between a merchant and an accountholder or a cardholder using a payment card or payment account such as a credit card or a debit card. For example, the credit card or debit card may be used at a point-of-sale (POS) device of a merchant (sometimes referred to as a card present or CP transaction), or in an online transaction through e-commerce (sometimes referred to as a card-not-present or CNP transaction), or at an automatic teller machine (ATM) to make a payment for a purchase of goods/services, transfer of money, and/or for a cash withdrawal. The particular POS, computing device, or ATM where the credit card or debit card is used is generally referred as a payment node or a payer. From the payment node, an electronic request message is sent to an acquirer bank. The acquirer bank may be the merchant or the bank of the merchant, and may be the owner of the POS or the ATM. After receiving the transaction request message through the network at another computer node, the acquirer bank may then generate and send an electronic authorization request message to an associated payment network system for processing the payment transaction. The card network's payment network system may then communicate with the issuer bank (the bank issuing the card or account) and may receive a response from the issuer bank which may indicate whether the transaction is approved or declined. The issuer bank is generally referred to as a funding node or a payee.

In other cases, payment requests or money transfer requests may occur between two individuals. These payment requests may occur as a push payment or as a pull payment. The push payment is where the funding node or the bank account of the payor pushes the money or funds out to the payee or the payment node. This may occur when a payor transfers money to a payee. In the case of the pull payment, the payee or the payment node may send a payment request to the payor or funding node, and request that the funds be transferred.

During a given day, between a payment node and a funding node, multiple transactions may be executed using multiple different credit cards or debit cards. Generally, most of the credit cards and debit cards transactions are legitimately performed by the legitimate owners of the credit cards or debit cards where payment is made to a legitimate payment node. However, sometimes these transactions are performed by fraudsters. In other words, fraudulent payees may attempt to access funds associated with legitimate credit cards or debit cards and attempt to transfer funds to a fraudulent payment node; or a fraudster may try to use a stolen credit card or debit card to purchase goods. In either case, fraud is being committed. In many cases, fraudsters may randomly try various credit cards and/or debit card account numbers in an attempt to send and/or receive money which may not have been known to the actual owners of the credit cards or debit cards or may not have been approved by the actual owners of the credit cards or debit cards.

Oftentimes, the fraudsters may use cards that are of a particular network brand or may be associated with a particular issuing bank (the fraudsters may use the Bank Identification Number (BIN) for a particular issuing bank) in order to initiate their fraudulent payment attempts. While the frauds may be either a push payment fraud or a pull payment fraud depending on the particular way in which the fraud payment is received, oftentimes the fraud may be reported by the owner of the credit card or debit card. However, the owner of the credit card or the debit card will typically identify the fraud with respect to a particular transaction and typically after the fraud is committed. Identification of a fraud at the transaction level is generally not enough to identify bad actors or fraudsters for various reasons including, but not limited to, incomplete information available for the alleged fraudulent transaction, incomplete or incorrect amount of fraud corresponding to the fraudulent transaction, fraud identified only for a particular account which can easily be changed by the fraudster, and so on. Most known fraud detection systems are also designed to evaluate for fraud at the transaction level and not at an account level. In other words, these known fraud detection systems will look at a particular transaction and decide if it is more likely fraud or not. These known systems are unable to evaluate for fraud at an account level—where the fraudster is identified and not just a particular transaction. These known systems typically are unable to account for personally identifiable information (PII) that may be associated with a particular transaction and how that PII may change from one transaction to another by a fraudster. So, these known systems are unable to detect bad actors that may repeatedly try to scam the system and commit fraud.

The computer network or computer infrastructure through which an acquirer node and an issuer node are connected is generally known as a transaction rail. When a payment request is initiated, data or information including customer account information and/or instructions for the financial institution may be shared using the rail. The transaction rail may be of many different types including account-to-account, single euro payments area (SEPA), society for worldwide interbank financial telecommunication (SWIFT), debit and credit card networks, cryptocurrency, faster payments, and/or clearing house automated payment system (CHAPS). While each transaction rail functions differently and offers certain advantages and/or disadvantages, a particular pattern of fraudulent transactions performed over one specific transaction rail may not be known to other transaction rails. In some examples, machine-learning models are required to be retrained or updated in order to detect fraudulent patterns. Until the machine-learning models are retrained or updated by one party of the transaction rail experiencing the fraud are then communicated to another entity of the same or different transaction rail, fraudulent transaction detection may not be sufficiently improved, and may cause a significant loss to the financial institution.

Accordingly, there is a need for a context driven generative AI system and method that is configured to evaluate all aspects of an account-to-account (A2A) ecosystem and to identify patterns of fraudulent transactions using personally identifiable information (PII) available at the account level, even when the account is an off-network account (e.g., an account associated with a second payment network used to receive money processed by a first network). Such a system would be able to detect bad actors within the present system and prevent these bad actors from committing repeated fraud within the present transaction rail system or other transaction rail systems, and thus, prevent widespread fraud attacks.

### BRIEF DESCRIPTION

In one aspect, a graphical modeling computer system including at least one memory, generative artificial intelligence (GAI) tools, and at least one processor in communication with the at least one memory and the GAI tools is disclosed. The at least one processor is configured to: (i) receive transaction data for a plurality of transactions including a first set of declined transactions and a second set of approved transactions; (ii) parse the transaction data to identify each pair of a respective payment node and a respective funding node associated with each transaction of the plurality of transactions; (iii) generate a graphical model including each payment node of a plurality of payment nodes, each funding node of a plurality of funding nodes, and a transaction edge between the payment nodes and funding nodes representing the transactions occurring between the payment nodes and the funding nodes; (iv) retrieve personally identifiable information (PII) for each transaction of the plurality of transactions; (v) train the graphical model to include PII embeddings by applying the PII to at least one of the payment nodes, the funding nodes, and the transaction edges; (vi) convert the graphical model into natural language sentences describing each transaction and the associated PII embeddings; (vii) generate, using the GAI tools, n-dimensional vector embeddings for the transactional edge embeddings, each n-dimensional vector embedding representing a transaction including the associated PII; (viii) build a final graphical model including approved transactions of the plurality of transactions initiated from each funding node to a corresponding payment node over a period of time and including the n-dimensional vector embeddings; (ix) train the final graphical model by applying a fraud identifying label to each fraudulent transaction of the plurality of transactions; and (x) apply the trained final graphical model to a subsequent transaction between a payment node of the plurality of payment nodes and a funding node of the plurality of funding nodes to determine if the subsequent transaction is a fraudulent transaction.

In another aspect, a computer-implemented method performed by a graphical modeling computer system including at least one memory, generative artificial intelligence (GAI) tools, and at least one processor in communication with the at least one memory and the GAI tools is disclosed. The computer-implemented method includes: (i) receiving transaction data for a plurality of transactions including a first set of declined transactions and a second set of approved transactions; (ii) parsing the transaction data to identify each pair of a respective payment node and a respective funding node associated with each transaction of the plurality of transactions; (iii) generating a graphical model including each payment node of a plurality of payment nodes, each funding node of a plurality of funding nodes, and a transaction edge between the payment nodes and funding nodes representing the transactions occurring between the payment nodes and the funding nodes; (iv) retrieving personally identifiable information (PII) for each transaction of the plurality of transactions; (v) training the graphical model to include PII embeddings by applying the PII to at least one of the payment nodes, the funding nodes, and the transaction edges; (vi) converting the graphical model into natural language sentences describing each transaction and the associated PII embeddings; (vii) generating, using the GAI tools, n-dimensional vector embeddings for the transactional edge embeddings, each n-dimensional vector embedding representing a transaction including the associated PII; (viii) building a final graphical model including approved transactions of the plurality of transactions initiated from each funding node to a corresponding payment node over a period of time and including the n-dimensional vector embeddings; (ix) training the final graphical model by applying a fraud identifying label to each fraudulent transaction of the plurality of transactions; and (x) applying the trained final graphical model to a subsequent transaction between a payment node of the plurality of payment nodes and a funding node of the plurality of funding nodes to determine if the subsequent transaction is a fraudulent transaction.

In yet another aspect, at least one non-transitory computer-readable storage media having machine-executable instructions stored thereon is disclosed, The instructions, when executed by at least one processor of a graphical modeling computer system in communication with at least one memory and generative artificial intelligence (GAI) tools of the graphical modeling computer system, cause the at least one processor to: (i) receive transaction data for a plurality of transactions including a first set of declined transactions and a second set of approved transactions; (ii) parse the transaction data to identify each pair of a respective payment node and a respective funding node associated with each transaction of the plurality of transactions; (iii) generate a graphical model including each payment node of a plurality of payment nodes, each funding node of a plurality of funding nodes, and a transaction edge between the payment nodes and funding nodes representing the transactions occurring between the payment nodes and the funding nodes; (iv) retrieve personally identifiable information (PII) for each transaction of the plurality of transactions; (v) train the graphical model to include PII embeddings by applying the PII to at least one of the payment nodes, the funding nodes, and the transaction edges; (vi) convert the graphical model into natural language sentences describing each transaction and the associated PII embeddings; (vii) generate, using the GAI tools, n-dimensional vector embeddings for the transactional edge embeddings, each n-dimensional vector embedding representing a transaction including the associated PII; (viii) build a final graphical model including approved transactions of the plurality of transactions initiated from each funding node to a corresponding payment node over a period of time and including the n-dimensional vector embeddings; (ix) train the final graphical model by applying a fraud identifying label to each fraudulent transaction of the plurality of transactions; and (x) apply the trained final graphical model to a subsequent transaction between a payment node of the plurality of payment nodes and a funding node of the plurality of funding nodes to determine if the subsequent transaction is a fraudulent transaction.

### BRIEF DESCRIPTION OF THE DRAWINGS

FIG. 1 is a schematic diagram illustrating an example multi-party payment processing system for enabling payment transactions between merchants, issuers, and cardholders.

FIG. 2 is diagram illustrating example payment transactions between a payment node and funding nodes in accordance with the present disclosure.

FIG. 3A is a diagram illustrating a graphical mapping of transactions from a transaction graph to an example embodiment of an account to account (A2A) graphical model.

FIG. 3B is a diagram showing an example embodiment of personally identifiable information (PII) being embedded to a payment node and a funding node of the A2A graphical model.

FIG. 3C is a diagram showing an example embodiment of the A2A graphical model where multiple payment nodes share certain data elements of the PII.

FIG. 3D is a diagram showing an example embodiment of the A2A graphical model including transactions over time between a funding node and payment nodes with the PII embedded therein as edge attributes.

FIG. 3E is a diagram showing the A2A graphical model with PII embeddings converted into a generative AI model including an n-dimensional vector with PII embeddings for an exemplary transaction stored in a transaction database.

FIG. 3F is a diagram showing the A2A graphical model with PII embeddings converted into a generative AI model including an n-dimensional vector with PII embeddings for another exemplary transaction stored in a transaction database.

FIG. 3G is a diagram showing an exemplary enhanced A2A graphical model with nodes and edges including the PII embeddings.

FIG. 3H is a diagram showing an exemplary two-stage model architecture for graphical neural network training.

FIG. 4 is a simplified block diagram of an example computer system configured to build, train, and apply the A2A graphical model and the two-stage graphical neural network model within the payment processing environment, shown in FIG. 1.

FIG. 5 illustrates an example configuration of a client device, or a cardholder computer device operated by a user, or a cardholder as shown in FIG. 1.

FIG. 6 illustrates an example configuration of the server computer system shown in FIGS. 1 and 4.

FIG. 7A and FIG. 7B illustrate a flow diagram of an example method of identifying fraudulent transactions, which may be implemented by the computer system shown in FIG. 6.

### DETAILED DESCRIPTION OF THE DISCLOSURE

The following detailed description illustrates embodiments of the disclosure by way of example and not by way of limitation. It is contemplated that the systems and processes described herein have general application to the aspect of processing payment card transactions. More specifically, the embodiments of the system and method described herein relate generally to identifying all aspects of an account-to-account (A2A) ecosystem, frauds and their scope at the account level, and bad actors (or fraudsters) committing frauds at the account level. Additionally, various embodiments describe techniques to identify such accounts operated by bad actors earlier to reduce the scope of frauds committed by the bad actors and in those cases where the transaction involves an off-network account. Accordingly, the system and method described herein is configured to detect payment accounts that are involved in fraudulent or suspicious activities at an early-stage while not mistakenly sharing certain features of personally identifiable information (PII) with the payment accounts involved in fraudulent or suspicious activities, and to deploy mitigation resources (e.g., computation resources to help mitigate the fraud) to address and/or prevent the fraud. The system and method described herein are able to capture a full view of the suspicious account activities and are able to differentiate legitimate transaction activities from the fraudulent activities. As compared to currently known systems that merely focus on each individual transaction, the system described herein focuses on transactions at an account level and PII associated with accounts and determines who the bad actors are at the account level.

Described in detail herein are example embodiments of a system and method for (i) receiving transaction data for a plurality of transactions including a first set of declined transactions and a second set of approved transactions; (ii) parsing the transaction data to identify each pair of a respective payment node, payment account or payor (generally referred to herein as a payment node) and a respective funding node, funding account, or payee (generally referred to herein as a funding node) associated with each transaction of the plurality of transactions; (iii) generating a graphical model including each payment node of a plurality of payment nodes, each funding node of a plurality of funding nodes, and transaction edges between the payment nodes and funding nodes representing the transactions occurring between the payment nodes and the funding nodes; (iv) retrieving personally identifiable information (PII) for each transaction of the plurality of transactions; (v) training the graphical model to include PII embeddings by applying the PII to at least one of the payment nodes, the funding nodes, and the transaction edges; (vi) converting the graphical model into natural language sentences describing each transaction and the associated PII embeddings; (vii) generating, using the GAI tools, n-dimensional vector embeddings representing changing PII for the transactional edge embeddings; (viii) generating, using the GAI tools, n-dimensional vector embeddings representing changing PII for the payment node embeddings or the funding node embeddings; and (ix) building a final graphical model including all transactions of the plurality of transactions initiated from each funding node to a corresponding payment node over a period of time and including the n-dimensional vector embeddings. The final graphical model is configured to identify changes in PII between transactions associated with a payment node of the plurality of payment nodes that indicate suspicious activity associated with the payment node.

Once the suspicious payment nodes are identified by the graphical node and edge model, a new graphical multi-layer model is created that focuses on each suspicious payment node and includes an analysis of each incoming transaction and corresponding PII, including edge attributes, to that node over a period of time and at different layers. For example, this suspicious multi-layer model is generated by graphically training the model to show (a) each incoming transaction for the selected payment node, and (b) the n-dimensional vector embeddings representing changing PII for the transactional edge embeddings, payment node embeddings, and/or funding node embeddings.

As described herein, transactions that are processed over a payment network may have features that are associated with each transaction. These features may include a variety of different data elements that are associated with each transaction. These features may be used as a profile for each transaction and indicate how, when, and where the transaction was performed. Additionally, the feature may also include personally identifiable information (PII) of the payment node and funding node associated with each transaction, as described herein below.

For example, the features of a transaction may be communicated over the payment network as part of an ISO8583 or ISO20022 compliant message through an authorization message or over the Internet through an authentication message associated with the transaction. The authentication message may, for example, use a 3DS2 protocol (or subsequent versions of the 3DS protocol) and include a variety of data elements associated with the transaction. These features are stored in memory and used as part of the AI tools when training a model to identify future fraudulent transactions and bad actors.

The following Table 1 lists a number of the data elements or features that are used in the 3DS2 Protocol for authentication. Those of skill in the art will appreciate that the number of rich data elements could grow beyond those listed below (e.g., in future versions of the 3DS Protocol), and could include over one hundred seventy data elements. Further, an app-based transaction (e.g., carried out using a mobile computing device) could provide even more data elements than browser-based transactions. In addition, a transaction performed using an Android device could have over one hundred thirty additional elements. The authentication data may also be divided by category, such as: transaction data (amount, currency, date, and time), device data (IP address, device info, and channel data), cardholder data (account number and shipping address), and merchant data (name, category, and country).

TABLE 1

| | Data Element |
|---|---|
| 1 | 3DS Requestor Authentication Information |
| 2 | 3DS Requestor Challenge Indicator |
| 3 | 3DS Requestor ID |
| 4 | 3DS Requestor Initiated Indicator |
| 5 | 3DS Requestor Name |
| 6 | 3DS Requestor Non-Payment Authentication Indicator |
| 7 | 3DS Requestor Prior Transaction Authentication |
| | Information |
| 8 | 3DS Requestor URL |
| 9 | 3DS Server Operator ID |
| 10 | 3DS Server Reference Number |
| 11 | 3DS Server Transaction ID |
| 12 | 3DS Server URL |
| 13 | Account Type |
| 14 | Acquirer BIN |
| 15 | Acquirer Merchant ID |
| 16 | ACS Challenge Mandated Indicator |
| 17 | ACS Counter ACS to SDK |
| 18 | ACS HTML |
| 19 | ACS Operator ID |
| 20 | ACS Reference Number |
| 21 | ACS Rendering Type |
| 22 | ACS Signed Content |
| 23 | ACS Transaction ID |
| 24 | ACS UI Type |
| 25 | Address Match Indicator |
| 26 | Authentication Method |
| 27 | Authentication Type |
| 28 | Authentication Value |
| 29 | Browser Accept Headers |
| 30 | Browser IP Address |
| 31 | Browser Java Enabled |
| 32 | Browser Language |
| 33 | Browser Screen Color Depth |
| 34 | Browser Screen Height |
| 35 | Browser Screen Width |
| 36 | Browser Time Zone |
| 37 | Browser User-Agent |
| 38 | Card/Token Expiry Date |
| 39 | Cardholder Account Identifier |
| 40 | Cardholder Account Information |
| 41 | Cardholder Account Number |
| 42 | Cardholder Billing Address City |
| 43 | Cardholder Billing Address Country |
| 44 | Cardholder Billing Address Line 1 |
| 45 | Cardholder Billing Address Line 2 |
| 46 | Cardholder Billing Address Line 3 |
| 47 | Cardholder Billing Address Postal Code |
| 48 | Cardholder Billing Address State |
| 49 | Cardholder Email Address |
| 50 | Cardholder Home Phone Number |
| 51 | Cardholder Mobile Phone Number |
| 52 | Cardholder Name |
| 53 | Cardholder Shipping Address City |
| 54 | Cardholder Shipping Address Country |
| 55 | Cardholder Shipping Address Line 1 |
| 56 | Cardholder Shipping Address Line 2 |
| 57 | Cardholder Shipping Address Line 3 |
| 58 | Cardholder Shipping Address Postal Code |
| 59 | Cardholder Shipping Address State |
| 60 | Cardholder Work Phone Number |
| 61 | Challenge Additional Information Text |
| 62 | Challenge Cancelation Indicator |
| 63 | Challenge Data Entry |
| 64 | Challenge HTML Data Entry |
| 65 | Challenge Information Header |
| 66 | Challenge Information Label |
| 67 | Challenge Information Text |
| 68 | Challenge Information Text Indicator |
| 69 | Challenge Selection Information |
| 70 | Challenge Window Size |
| 71 | Device Channel |
| 72 | Device Information |
| 73 | Device Rendering Options Supported |
| 74 | DS Reference Number |
| 75 | DS Transaction ID |
| 76 | DS URL |
| 77 | Electronic Commerce Indicator |
| 78 | EMV Payment Token Indicator |
| 79 | Expandable Information Label 1 |
| 80 | Expandable Information Text 1 |
| 81 | Instalment Payment Data |
| 82 | Interaction Counter |
| 83 | Issuer Image |
| 84 | Merchant Category Code |
| 85 | Merchant Country Code |
| 86 | Merchant Name |
| 87 | Merchant Risk Indicator |
| 88 | Message Category |
| 89 | Message Extension |
| 90 | Message Type |
| 91 | Message Version Number |
| 92 | Notification URL |
| 93 | OOB App Label |
| 94 | OOB App URL |
| 95 | OOB Continuation Indicator |
| 96 | OOB Continuation Label |
| 97 | Payment System Image |
| 98 | Purchase Amount |
| 99 | Purchase Currency |
| 100 | Purchase Currency Exponent |
| 101 | Purchase Date & Time |
| 102 | Recurring Expiry |
| 103 | Recurring Frequency |
| 104 | Resend Challenge Information Code |
| 105 | Resend Information Label |
| 106 | Results Message Status |
| 107 | SDK App ID |
| 108 | SDK Counter SDK to ACS |
| 109 | SDK Encrypted Data |
| 110 | SDK Ephemeral Public Key (Qc) |
| 111 | SDK Reference Number |
| 112 | SDK Transaction ID |
| 113 | Submit Authentication Label |
| 114 | Transaction Status |
| 115 | Transaction Status Reason |
| 116 | Transaction Type |
| 117 | Why Information Label |
| 118 | Why Information Text |

The authorization message is in an ISO 8583 or ISO 20022 message format for processing over a dedicated payment processing network. As used herein, “ISO” refers to a series of standards approved by the International Organization for Standardization (ISO is a registered trademark of the International Organization for Standardization of Geneva, Switzerland). ISO 8583 compliant messages are defined by the ISO 8583 standard which governs financial transaction card originated messages and further defines acceptable message types, data elements, and code values associated with such financial transaction card originated messages. ISO 8583 compliant messages include a plurality of specified locations for data elements. ISO 20022 compliant messages are defined by the ISO 20022 standard. For example, ISO 20022 compliant messages may include acceptor to issuer card messages (ATICA).

By way of a non-limiting example, the data elements may also include the PII of the payment node and/or a funding node. The PII of the payment node may include, but is not limited to, the following features: (i) a first name and a last name of the account holder; (ii) a state and/or a country in which the account holder is living or with which the payment node is associated; and/or (iii) an account number and/or an account type associated with the payment node. Similarly, the PII of the funding node may include, but is not limited to, the following features: (i) a first name and a last name of the account holder; (ii) a street address, a city, a state and/or a country in which the account holder is living or with which the funding node is associated; and/or (iii) an account number and/or an account type associated with the funding node. The state and/or the country associated with the payment node and/or the funding node may be represented using a state code and/or a country code.

Accordingly, each transaction stored in a database may have a payment node and a funding node, and the PII associated with the payment node and the funding node. The transactions stored in the database may be used to generate a dense graph or an account-to-account (A2A) graphical model (or simply referenced herein as a graphical model) in which transactions performed between a plurality of payment nodes and a plurality of funding nodes, each with its respective PII, may be identified. Based on the graphical model, in some cases, it may be observed that the transactions that are either reported as fraudulent transactions or identified as fraudulent transactions are associated with the same payment node which has certain features of its PII changing between different transactions (while certain other features of its PII remain the same). In the exemplary embodiment, the payment node may have a different first name and/or last name between transactions while the payment node may be performing fraudulent activities. Additionally, or alternatively, other features of the PII such as a state code and/or a country code may also be changed between transactions as part of or for performing fraudulent activities. In other words, multiple payment nodes may have most features of the PII common among them, but certain features (for example, the first name and/or last name) may change over time and/or between transactions. Accordingly, the PII, and in particular, changes in certain PII features, may be used to distinguish payment nodes associated with or involved in fraudulent activities from payment nodes having, for example, the same first name and/or last name but that are not associated with or involved in fraudulent activities (e.g., from the payment nodes conducting legitimate transactions).

In some embodiments, transactions stored in a transaction database may be used to build or generate the A2A graphical model that associates certain (but not necessarily all) features of the PII of the payment nodes and/or funding nodes with the nodes of the A2A graphical model. A transaction between two nodes is illustrated in the graphical model as a node-to-node connection referred to as an edge. Features of the PII are illustrated as edge attributes that may be associated with an edge. By way of a non-limiting example, edge attributes are features of the PII which may be generally changed between transactions to perform fraudulent activities. Edge attributes of each edge (e.g., a transaction performed) between the payment node and the funding node may be associated and displayed in the generated graphical model. Using a combination of edge attributes (e.g., certain features of the PII), payment nodes not involved in fraudulent activities may avoid being associated with payment accounts having certain edge attributes (e.g., PII features) that have the same value(s). However, this methodology involves several technical problems, including computational complexities resulting from each edge attribute having to be treated as a category and then needing either one-hot encoding or an embedding layer and from the general increase in complexity associated with using a graph-based approach (i.e., the dense graph or A2A graphical model). Moreover, given the limited context for determining changing PII features (i.e., edge attributes) among different transactions, a slight change in PII features over time may not be easily captured.

In some embodiments, for a payment node connected with a funding node in the generated graphical model, different edge attributes (e.g., PII features) of an edge may be converted or presented using a predefined template or natural language. Specifically, the PII features (e.g., edge attributes) may be used to generate a sentence using the predefined template or natural language. In the present disclosure, PII features may be referenced as PII embeddings, as well.

In one example, a transaction of the graphical model generated based on a plurality of transactions performed between a payment node and a funding node at time t having edge attributes including a first name, a last name, a state code, a country, and a city may be converted using a predefined template or natural language into a sentence such as “<first name> <last name> with account number <Account Number> residing in <city> and unknown state receives money from account number <Funding Account Number> at the nth hour of day dd.” A plurality of transactions stored in the database and used for generating the graphical model may be converted into sentences as described herein. The sentences may then be used to leverage generative AI tools to construct n-dimensional vector embedding layers that captures a change in context based on changes to one or more features of the PII.

In another example, a transaction, of the graphical model generated based on a plurality of transactions, performed between a merchant (e.g., a particular type of payment account) and a funding node at time t having edge attributes including, but not limited to, account specific information (e.g., a card type), a payment method (e.g., card present/card not present (CP/CNP), wallet, PEM (public encryption key information), domestic/cross-border (XBR)), an amount, information about a merchant (e.g., merchant's location, past transactions performed by the merchant, merchant category code (MCC)), and a list of risk indicators (e.g., a number of chargebacks, a number of declined and/or fraud transactions) may be converted using a predefined template or natural language into a sentence, such as “User <user name> purchases a product worth $x at the n^{th} hour of day dd from a merchant <merchant name>; in past the user <user name> has interacted with merchant <merchant name> n times and has experienced <a number of declined transactions> declines and raised chargebacks worth $y, whereas the merchant has existed for last P years and has totals sales volume of <sales volume amount> with total reported frauds and chargebacks worth <fraudulent and chargeback amount totals>.” A plurality of transactions stored in the database and used for generating the graphical model corresponding to merchants as payment nodes may be converted into sentences as described herein. The sentences may be then used to leverage generative AI tools to construct n-dimensional vector embedding layers that capture a change in an evolving history of a merchant as the payment node and various funding nodes and/or a change in an evolving history of a funding node and various merchants as payment nodes.

In an exemplary embodiment, transactions occurring at different times between a funding node and various payment nodes may be represented using sentences in natural language based on the PII features (e.g., edge attributes) of the corresponding transactions (e.g., edges between the nodes). A time-based transactions graph illustrating certain transactions between the funding node and various payment nodes at a plurality of times may be used to generate a graphical model showing approved transactions (e.g., transactions in which a money transfer occurred) and declined transactions (e.g., transactions in which a money transfer did not occur). The declined transactions may be declined for many reasons including the transactions being suspected of being fraudulent transactions. The graphical model showing approved and/or declined transactions may be generated based on the n-dimensional vector embeddings generated using generative AI. By way of a non-limiting example, the graphical model may be generated or trained in a self-supervised learning setting. During the self-supervised learning, based on the generated n-dimensional vector embeddings, as described herein, corresponding to nodes and/or edges, fraudulent transactions and/or nodes involved in fraudulent activities may be identified.

The graphical model generated in a self-supervised learning setting may be fine-tuned during a next stage such that it only includes various nodes and their edges along with corresponding edge embeddings (e.g., n-dimensional vector embeddings) for approved transactions (e.g., for transactions in which a money transfer occurred). In other words, the fine-tuned graphical model would not include declined transactions or transactions that are known to be fraudulent and would represent a fully connected neural network layer. The fully connected layer with nodes associated with n-dimensional vector embeddings may help to identify edge attributes (e.g., specific features of PII) changing between transactions and, therefore, help to identify payment nodes involved in fraudulent activities.

The neural network-based model including the fully connected layer may be deployed or used to process transactions between nodes to generate embeddings for the nodes and edges, and when the n-dimensional vector embeddings indicate changes in edge attributes or significant departure for other vector embeddings for the nodes or edges, the node may be identified as a node involved in fraudulent activities.

The methods and systems described herein may be implemented using computer programming or engineering techniques including computer software, firmware, hardware or any combination or subset thereof, wherein the technical effect may be achieved by performing at least one of the following steps: (1) receiving transaction data for a plurality of transactions including a first set of declined transactions and a second set of approved transactions; (2) parsing the transaction data to identify each pair of a respective payment node and a respective funding node associated with each transaction of the plurality of transactions; (3) generating a graphical model including each payment node of a plurality of payment nodes, each funding node of a plurality of funding nodes, and transaction edges between the payment nodes and funding nodes representing the transactions occurring between the payment nodes and the funding nodes; (4) retrieving personally identifiable information (PII) for each transaction of the plurality of transactions; (5) training the graphical model to include PII embeddings by applying the PII to at least one of the payment nodes, the funding nodes, and the transaction edges; (6) converting the graphical model into natural language sentences describing each transaction and the associated PII embeddings; (7) generating, using generative artificial intelligence (GAI) tools, n-dimensional vector embeddings for the transactional edge embeddings, each n-dimensional vector embedding representing a transaction including the associated PII; (8) building a final graphical model including approved transactions of the plurality of transactions initiated from each funding node to a corresponding payment node over a period of time and including the n-dimensional vector embeddings; (9) training the final graphical model by applying a fraud identifying label to each fraudulent transaction of the plurality of transactions; and (10) applying the trained final graphical model to a subsequent transaction between a payment node of the plurality of payment nodes and a funding node of the plurality of funding nodes to determine if the subsequent transaction is a fraudulent transaction.

As used herein, an acquiring bank or acquirer is typically a bank (or financial institution) at which a merchant holds an account. Further, an issuing bank or issuer (or financial institution) is typically a bank at which a customer or cardholder holds an account. The account may be debited or charged through the use of a debit card, a credit card, or another type of payment card as described herein.

As used herein, the terms “payment card,” “financial transaction card,” and “transaction card” refer to any suitable payment card, such as a credit card, a debit card, a prepaid card, a charge card, a membership card, a promotional card, a frequent flyer card, an identification card, a gift card, and/or any other device that may hold payment account data, such as mobile phones, smartphones, smart cards, digital wallets, personal digital assistants (PDAs), key fobs, and/or computers. Each type of payment card can be used as a method of payment for performing a transaction.

As used herein, the term “network processor” or “payment processor” and related terms (e.g., “home network processor”) refers to computer system(s) associated with a payment network that may be used to communicate data between computer systems associated with an issuer bank, a cardholder, a merchant, an acquirer bank, a payment aggregator, a payment gateway, a government, a financial technology (“Fintech”) system, and/or an account clearing house (“ACH”) system, and communicate with off-network computer system(s) that may be used to provide marketplace operations. Also, as used herein, the home network processor may be configured to receive marketplace operation requests from a requestor and send marketplace operation requests to the translation module or directly to the off-network marketplace or marketplace providers.

As used herein, a funding node is a person or an entity that is sending or transferring the requested funding amount to the payment node when requested by the payment node when the requested transaction is approved or authorized by the funding node. In case the requested transaction is declined, no funding amount may be transferred to the payment node.

As used herein, a processor includes a programmable system including systems using microcontrollers, reduced instruction set circuits (RISC), application specific integrated circuits (ASICs), logic circuits, and any other circuit or processor capable of executing the functions described herein. The above examples are example only, and thus are not intended to limit the definition and/or meaning of the term “processor” in any way.

In one embodiment, computer-executable instructions are provided and are embodied on a non-transitory computer readable storage medium. The computer-executable instructions cause a computer executing the instructions to utilize a Structured Query Language (SQL) with a client user interface front-end for administration and a web interface for standard user inputs and reports. In an example embodiment, the system is web-enabled and is run on a business entity intranet. In an alternative embodiment, the system is fully accessible by individuals having authorized access from outside a firewall of the business-entity through the Internet. In a further alternative embodiment, the system is run in a Windows® environment (Windows is a registered trademark of Microsoft Corporation, Redmond, Wash.). The application is flexible and designed to run in various different environments without compromising any major functionality.

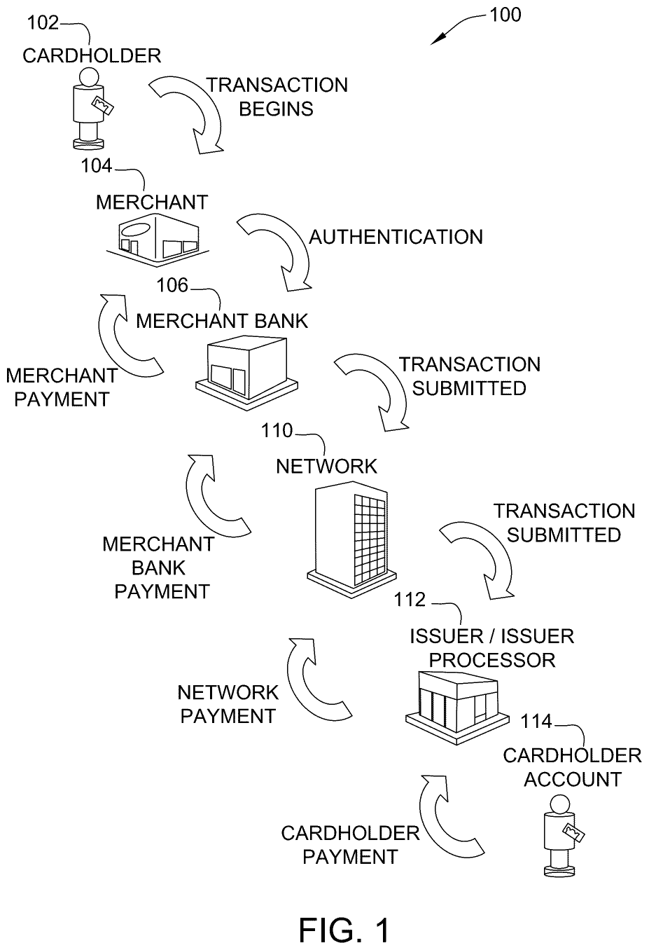

FIG. 1 is a schematic diagram illustrating an example multi-party payment processing system 100 for enabling payment transactions between merchants, issuers, and cardholder. For example, merchants 104 and card issuers 112 shown in the multi-party payment processing system 100 may not necessarily have a direct, one-to-one interaction. Embodiments described herein may relate to a payment processing system, such as a credit card or debit card payment processing system or a direct payment processing system that uses the Mastercard® interchange network (Mastercard is a registered trademark of Mastercard International Incorporated located in Purchase, New York). The Mastercard interchange network is a set of proprietary communications standards promulgated by Mastercard International Incorporated for the exchange of financial transaction data and the settlement of funds between financial institutions that are members of Mastercard International Incorporated.

In a typical payment card system, a financial institution called the “issuer” issues a payment card, such as a credit or debit card, to a consumer or cardholder 102, who uses the payment card to tender payment for a purchase from a merchant 104. To accept payment with the payment card, merchant 104 must normally establish an account with a financial institution that is part of the financial payment system. This financial institution is usually called the “merchant bank,” the “acquiring bank,” or the “acquirer,” such as a merchant bank 106. When cardholder 102 tenders payment for a purchase with a payment card, merchant 104 sends an authorization request message to merchant bank 106 for the amount of the purchase. The request may be performed over the telephone, but may be also performed through the use of a computer system having access to a website or app enabling input of cardholder's 102 account information, or the use of a point-of-sale device, which reads cardholder's 102 account data from a magnetic stripe, a chip, or embossed characters on the payment card and communicates electronically with the transaction processing computers of merchant bank 106. Alternatively, merchant bank 106 may authorize a third party to perform transaction processing on its behalf. In this case, the point-of-sale device will be configured to communicate with the other party. Such other party is usually called a “merchant processor,” an “acquiring processor,” or a “third party processor.”

The merchant bank 106 forwards the authorization request message to an interchange network 110. The interchange network 110 may use authentication products to prevent fraud (e.g., a fraud in a card-not-present (CNP) transaction) and so on. Various authentication products that are used for CNP transaction fraud includes an address verification service, a card verification value, a digital transaction insight (DTI) score generation, a decision intelligence (DI) score generation, and/or information about the merchant such as whether the merchant is included on a blacklist or not, and so on. The interchange network 110 may forward the authorization request with a DI score and/or a DTI score to issuer 112.

Issuer 112 may determine whether cardholder's 102 account 114 is in good standing and whether the purchase is covered by cardholder's 102 available credit limit. Based on these and other determinations, the request for authorization will be declined or accepted. When the request is accepted, an authorization code is issued to merchant 104. And when the request is declined, a reason code may be included in the response message from the issuer 112 to the interchange network 110. The reason code for the declined financial transaction may identify a particular category and a reason for which the financial transaction is declined. However, the reason code specified in the response message to interchange network 110 does not specify which declined transaction is a fraudulent transaction.

The reason code for a declined financial transaction may identify a particular category and a reason for which the financial transaction is declined. For example, a reason code 51 may suggest that the financial transaction is declined due to financial reasons such as insufficient fund, or the financial transaction is over the credit limit. Reason codes 14, 54, and 78 indicate that the financial transaction is being declined due to lifestyle reasons such as an invalid card number, an expired card, and an invalid or a non-existent account number, respectively. When a financial transaction is declined due to policy reasons, a reason code 65 may be used to suggest that the financial transaction exceeds withdrawal count limit, a reason code 75 may be used to indicate an allowable number of PIN attempts are exceeded, and a reason code 62 may be used to suggest that the card is restricted. A financial transaction may be declined for security reasons, and reasons codes 04, 43, and 55 identify security reasons for which the financial transaction is declined. The reason code 04 may suggest that the card is a captured card. The reason code 43 may suggest that the card is a stolen card, and the reason code 55 may suggest that an invalid PIN is used. The financial transaction may be declined due technical reasons, and reason codes 80 and 30 may be used to suggest a network error and a format error, respectively. A reason code 15 may suggest an invalid issuer.

However, the reason code specified in the response message to interchange network 110 does not specify which declined transaction is a fraudulent transaction. For example, when a reason code 34 is included in the response message by the issuer 112, the interchange network 110 may know that the issuer 112 has declined the authorization request for a suspected fraud in the credit card number (or debit card number), and when a reason code 83 is included in the response message by the issuer, the interchange network 110 may know that the issuer 112 has declined the authorization request as the issuer 112 believes the authorization request is for a fraudulent transaction. Authorization requests for which a reason code 34 and/or a reason code 83 is returned may result in the associated transaction being labeled as a fraudulent transaction by the interchange network 110. However, when the issuer 112 declines an authorization request with a reason code 05 meaning “Do Not Honor,” the issuer 112 indicates to the interchange network 110 that the issue 112 has declined the authorization request but has not identified the corresponding transaction as a fraudulent transaction. Accordingly, declined transactions with reason codes 34 and/or 83 may be labeled as fraudulent transactions, but declined transactions with reason code 05 may not be labeled as fraudulent transactions.

Since the authorization requests are declined based on the risk models or fraud detection models used by the issuer 112, and as the more fraudulent transactions are identified by the issuer 112, more fraudulent definitions (or patterns) of the fraudulent transactions may be added to a database of declined transactions (or fraudulent transactions) of the issuer 112. However, the interchange network 110 and/or the acquirer (or the merchant bank 106) may not be aware of these emerging fraud patterns or the bad actors or fraudsters whose transactions are getting declined by the issuer 112.

FIG. 1 above thus describes an operational flow of transactions between the merchant (or acquirer) and the issuer. The merchant (or acquirer) may be referred to as a payment node and the issuer may be referred to as a funding node as described above. In addition to the payment card transaction described above, system 100 may also be used for pushing or pulling money between parties. In other words, instead of initiating a payment made to a merchant at a website or at a POS device, the payment transaction may be initiated using an app that allows a party to send or receive money from another party. In this case, the party that receives the payment (or the party's account) is the payment node and the party (or the party's account) that is sending the money is the funding node.

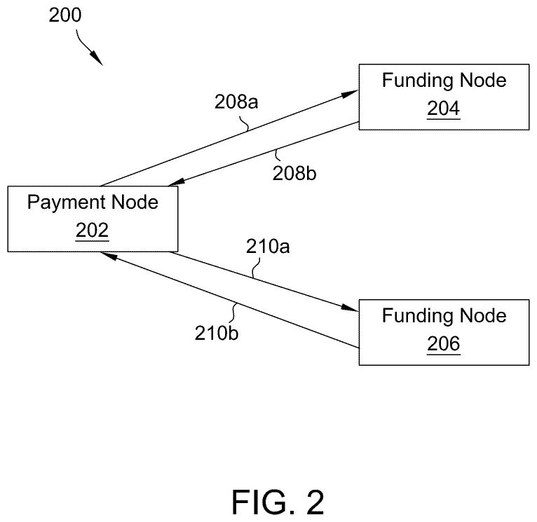

FIG. 2 is a diagram 200 illustrating example payment transactions between a payment node (or a payee or payee device) 202 and two different funding nodes (or payors or payor devices) 204 and 206. The payment system 200 is similar to system 100 shown in FIG. 1. The payment node 202 may be associated with a plurality of different payment cards or account numbers. For example, the payment node 202 may utilize the same payment card and/or different payment cards when receiving payments from funding nodes 204 or 206. In some cases where payment node 202 is a fraudster or bad actor, the payment node 202 may attempt multiple transactions (pull payments) using different payment cards with the same funding node (e.g., the funding node 204 or the funding node 206). Additionally, or alternatively, the payment node 202 may attempt a first set of transactions using a first set of payment cards with the funding node 204 and a second set of transactions using a second set of payment cards with the funding node 206. The cards included in the first set of cards may or may not be included in the second set of cards. The payment node may change or update certain features of PII, for example, the first name and/or the last name, between transactions during fraudulent activities.

In the example embodiment, the payment node 202 may send a request for authorization 208a to the funding node 204 for a transfer of a funding amount from an account associated with the funding node 204, and the funding node 204 may decline the request for authorization and send a declined response 208b. The payment node 202 may send a request for authorization 210a to the funding node 206 for a transfer of a funding amount from an account associated with the funding node 206, and the funding node 206 may approve the request for authorization and send an approved response 210b. Both requests for authorizations 208a and 210a may be initiated with an intent to commit fraud using different cards. However, the funding node 204 may decline the authorization request 208a for some reasons, and the funding node 206 may approve the authorization request 210a. Accordingly, while the payment node 202 attempts to commit fraud using many different cards, the payment node 202 may succeed in committing fraud with certain payment cards and/or with certain funding nodes and may fail in committing fraud with certain payment cards and/or with certain funding nodes. As stated herein, the payment node 202 may use a different combination of the first name and the last name for transactions 208a and 210a with the funding nodes 204 and 206.

In some examples, the payment node 202 may try committing fraud changing certain PII features. In other words, the payment node 202 may use the same BIN number (e.g., a sequence of the first four or six digits of the payment card that identifies the issuing bank) while trying random numbers for the remaining numbers of the payment card. Accordingly, in order to identify bad actors (or fraudsters), graphical modeling may be performed to identify edges (e.g., transactions) between nodes (payment nodes and funding nodes) along with edge attributes (e.g., PII features) that are generally known as being used by payment nodes involved in fraudulent activities. In some examples, by using the graphical modeling approach at the account level (or a payment node level), fraud detection at the transaction level may be improved. The payment node may be within the payment processing network or outside the network and based on the graphical modeling approach at the payment node level, funds may be traced including identifying the path from where the funds were transferred and to which destination account. Accordingly, based on the graphical modeling approach at the node level (e.g., the payment node and/or the funding node), a set of profile features, e.g., edge attributes, may be determined that may improve a fraud detection model that is configured to identify bad actors or fraudsters. In other words, once a bad actor payment node is identified, the set of edge attributes associated with that bad actor analyzed over time may be used to identify other bad actors and may be used to decline transactions associated with the identified bad actors or fraudsters at the interchange network 110.

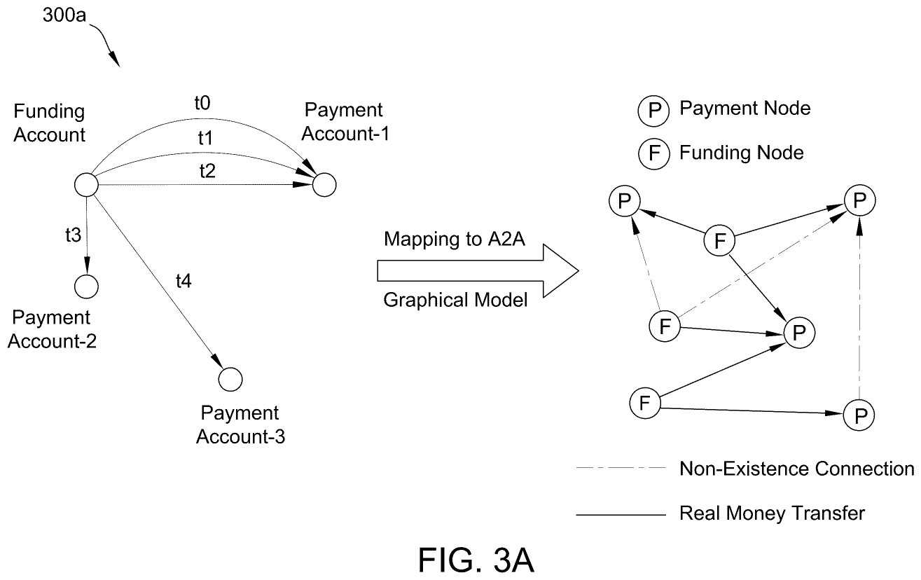

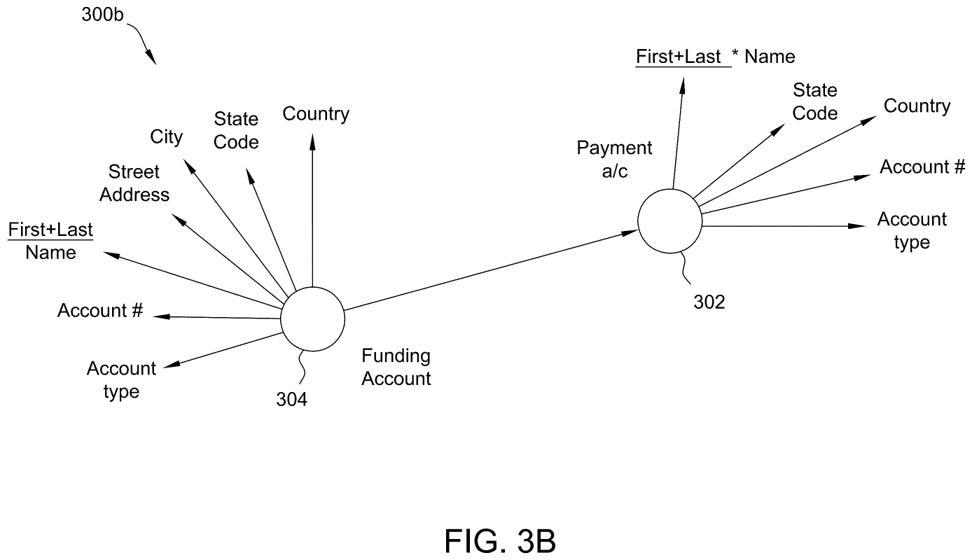

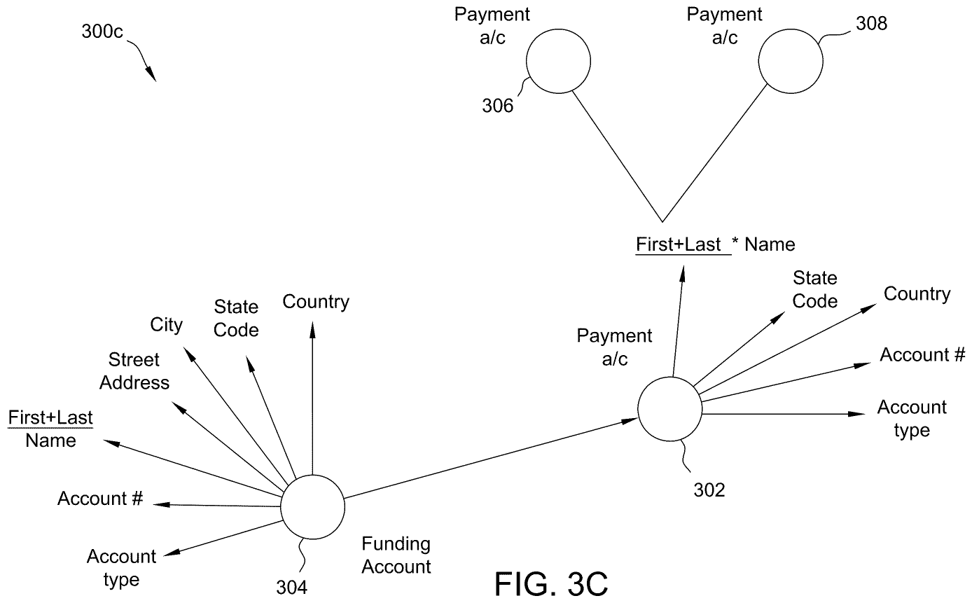

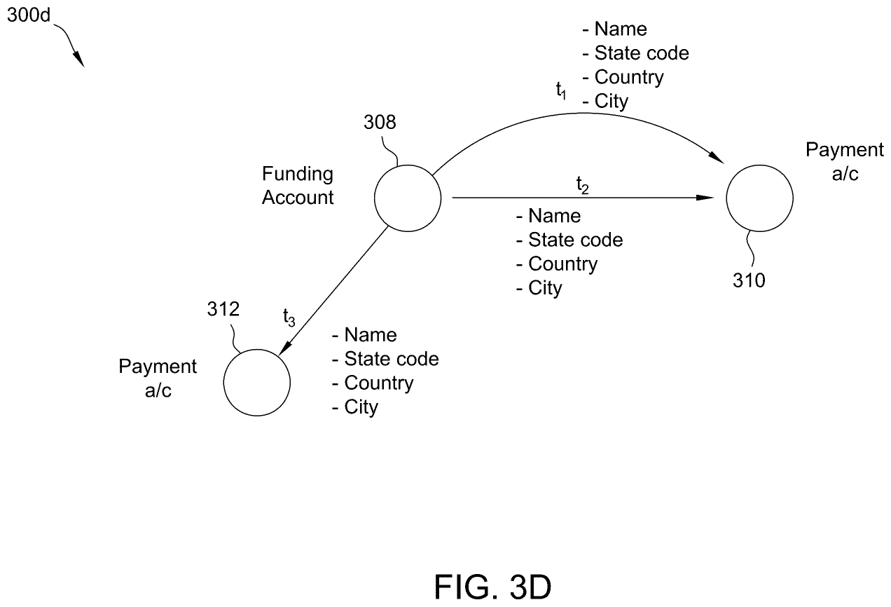

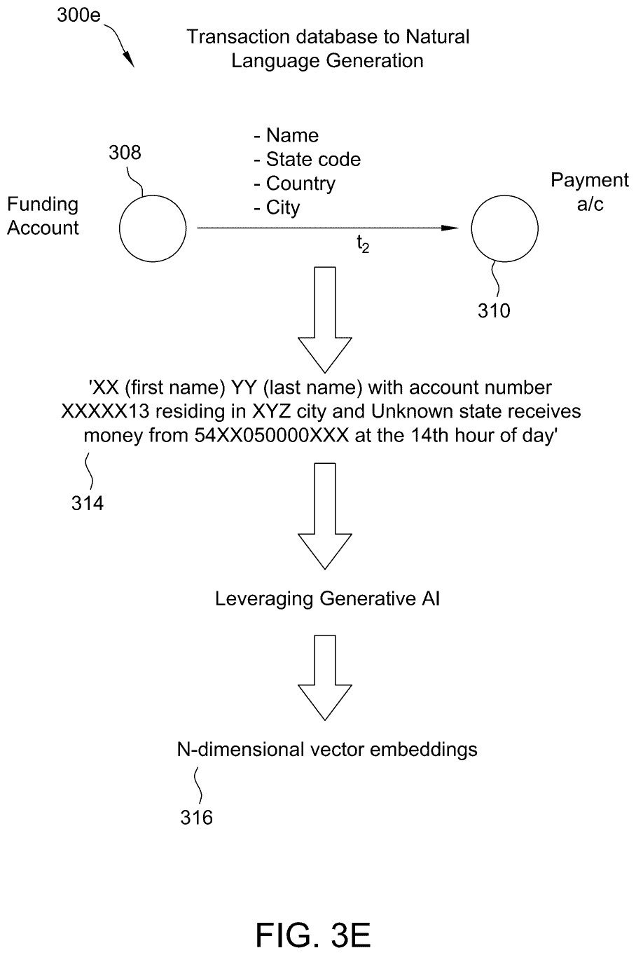

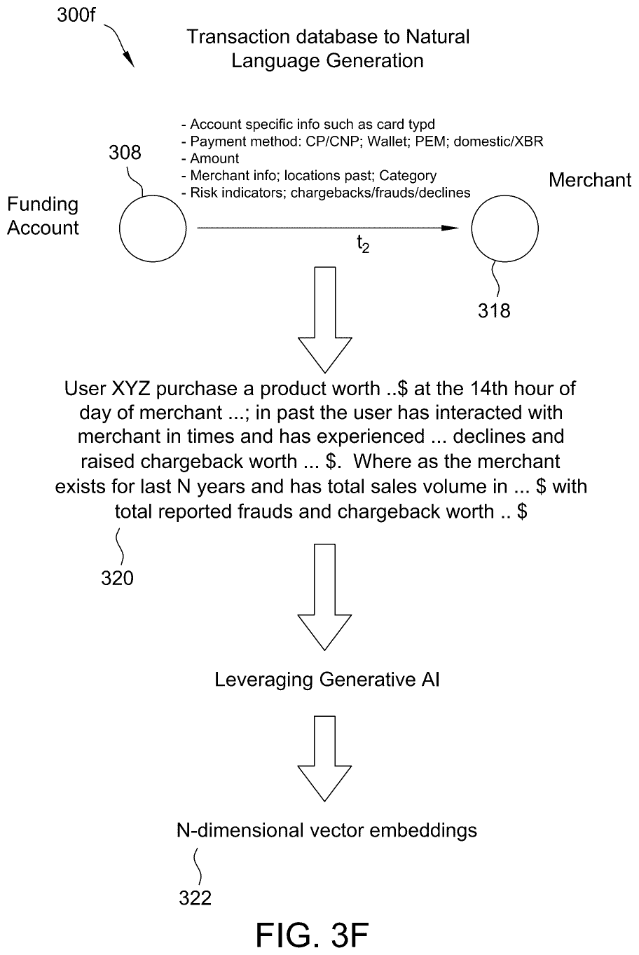

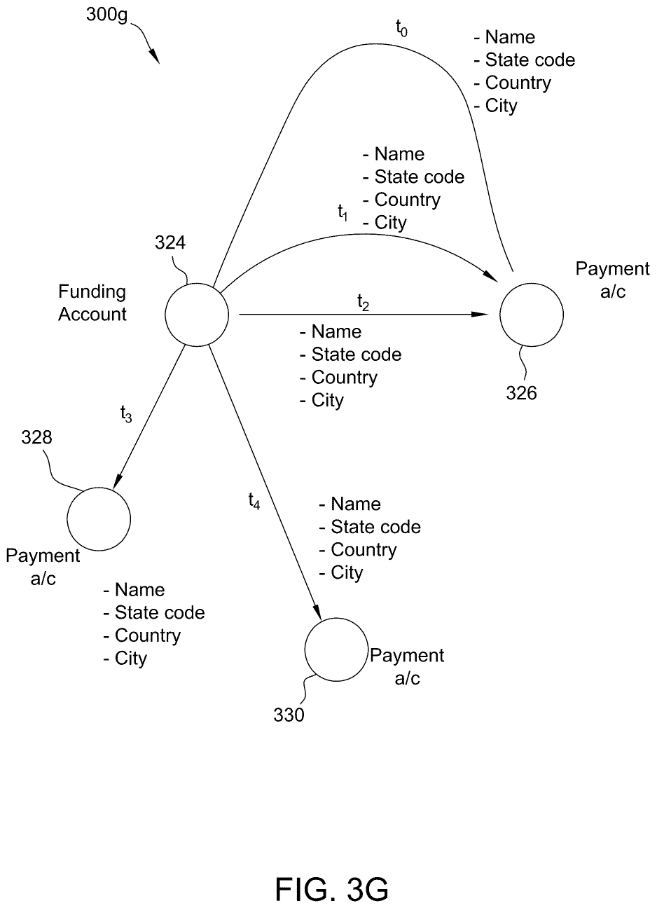

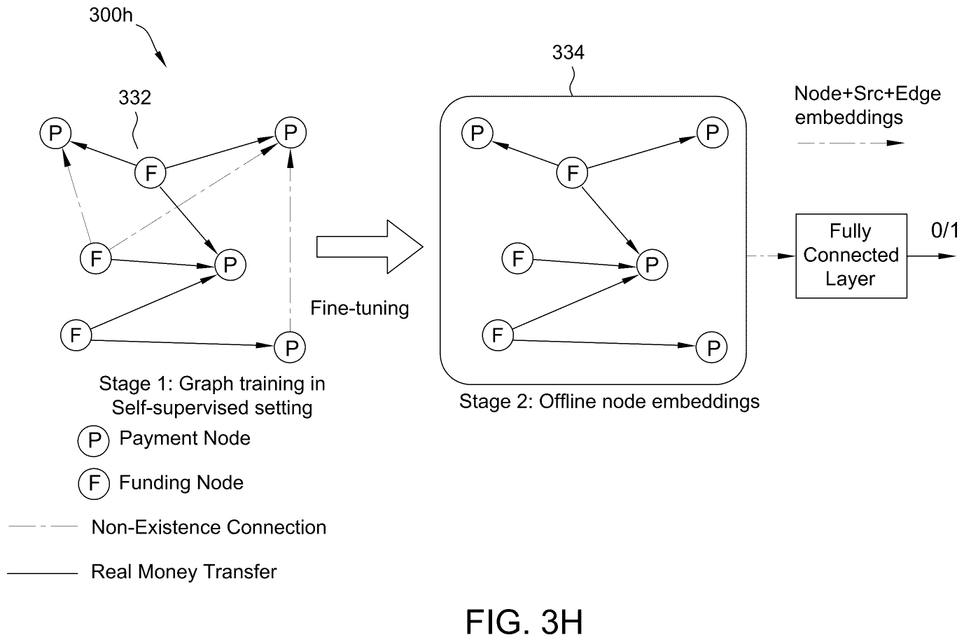

FIG. 3A is a diagram illustrating a graphical mapping of transactions from a transaction graph to an example embodiment of an account-to-account (A2A) graphical model with nodes and edges. Specifically, FIG. 3A illustrates a mapping of an A2A graphical model 300a based on a plurality of transactions between one or more funding nodes and a plurality of payment nodes. In FIG. 3A, a plurality of transactions t₀, t₁, t₂, t₃, and t₄ are shown as being performed over time between the funding account and several different payment accounts including payment account-1, payment account-2, and payment account-3. In other embodiments, other payment nodes and funding nodes along with other transactions could also be included. In FIG. 3A, transactions t₀, t₁, and t₂ are shown as being between the funding account and payment account-1, while transactions t₃ and t₄ are performed between the funding account and payment account-2 and between the funding account and payment account-3, respectively. While the transactions, the funding account, and the payment accounts shown in FIG. 3A are for example only, other transactions which occurred at different times between the payment nodes and the funding node may also be similarly mapped to an A2A graphical model (also referenced herein as the graphical model), as shown in FIG. 3A. The graphical model shows the connections and/or transactions between various account nodes (e.g., payment nodes and/or funding nodes). As described herein, the payment node is a receiver of funds (e.g., a payee), and the funding node is a sender of funds (e.g., a payor) in a transaction. Accordingly, from the plurality of transactions that are performed at different times over a specific period, the A2A graphical model may be generated showing one or more payment nodes and one or more funding nodes associated with the plurality of transactions performed over time. In some embodiments, by way of a non-limiting example, the plurality of transactions used for generating the A2A graphical model may include transactions performed over the past 120 days or any other period of time.

In other words, exemplary embodiments of the graphical model described herein may include identifying all transactions initiated within an account-to-account (A2A) ecosystem including features associated with each transaction and building a transaction graphical model showing all transactions initiated from one or more funding sources (or payors or funding nodes) to one or more payment receiving sources (or payees or payment nodes) over a period of time.

FIG. 3B is a diagram 300b showing an example embodiment of personally identifiable information (PII) being embedded to a payment node 302 and a funding node 304 of the A2A graphical model shown in FIG. 3A. As described herein, transactions performed between payment nodes, e.g., the payment node 302, and funding nodes, e.g., the funding node 304, processed over a payment network may have features that are associated with each transaction. These features are a variety of different data elements that are associated with each transaction. These features may be used as a profile for each transaction and indicate how, when, and where the transaction was performed. Additionally, the feature may also include personally identifiable information (PII) of the payment node 302 and funding node 304 associated with each transaction.

By way of a non-limiting example, the data elements may also include the PII of the payment node 302 and/or the funding node 304. The PII of the payment node 302 may include, but is not limited to, (i) a first name and a last name of the account holder; (ii) a street address, a city, state, and/or a country in which the account holder is living or with which the payment node is associated; and/or (iii) an account number and/or an account type associated with the payment node. Similarly, the PII of the funding node 304 may include, but not limited to, (i) a first name and a last name of the account holder; (ii) a street address, a city, a state, and/or a country in which the account holder is living or with which the funding node is associated; and/or (iii) an account number and/or an account type associated with the funding node. The state and/or the country associated with the payment node 302 and/or the funding node 304 may be represented using a state code and/or a country code.

FIG. 3C is a diagram, 300c showing an example embodiment of the A2A graphical model where multiple payment nodes share certain data elements or features of the PII. As shown in FIG. 3C, payment nodes 306 and 308 also share the first name and the last name of the payment node 302. Each transaction stored in a database may have a payment node and a funding node, and PII associated with the payment node and the funding node. Based on the graphical model, a plurality of payment nodes and a plurality of funding nodes with their respective PII may be identified. Based on the graphical model, it may be observed that the transactions that are either reported as fraudulent transactions or identified as fraudulent transactions are associated with the same payment node, which has certain features of the PII changing between different transactions. In the exemplary embodiment, the payment node may have a different first name and/or last name between transactions (but may maintain certain other features such as address, city, and state) while the payment node may be performing fraudulent activities. Additionally, or alternatively, other features of PII such as a state code and/or a country code may also be changed between transactions for performing fraudulent activities (while maintaining, for example, the same first name and last name). In other words, multiple payment nodes may have most features of the PII common among them, while certain other features may be changing with time and/or between transactions. Using at least some known processes, if the payment node 302 is identified as involved in fraudulent activities and payment nodes 306 and 308 have the same first name and/or the last name as payment node 302 but different other PII features, payment nodes 306 and 308 may be treated as being associated with the payment node 302 even though they may not be. The present system addresses this shortcoming by analyzing all changes in PII features.

FIG. 3D is a diagram 300d of an example embodiment of the A2A graphical model including transactions over time between a funding node and payment nodes with the PII embedded therein as edge attributes. Specifically, FIG. 3D illustrates transactions between a funding account 308 and payment accounts 310 and 312 performed over time, e.g., at time t₁, t₂, and t₃. In FIG. 3D, transactions at time t₁ and t₂ are shown as transactions between the funding account 308 and payment account 310, while the transaction at time t₃ is performed between the funding account 308 and payment account 312. Each transaction has a funding account and a payment account associated with the transaction. Each transaction therefore may have PII features identifying the transaction. As shown in FIG. 3D, PII features identifying the transaction, which are referenced herein as edge attributes, may include a name (e.g., first name and/or last name), a state code, a country, and/or a city. Each PII feature may be considered as a category and represented using a one-hot encoding or an embedding layer. Further, using a combination of edge attributes or certain PII features, payment nodes not involved in fraudulent activities may avoid being erroneously associated with payment nodes having similar PII features that have been involved in fraudulent activities.

FIG. 3E is a diagram 300e showing the A2A graphical model with PII embeddings converted into a generative AI model including an n-dimensional vector with PII embeddings for an exemplary transaction stored in a transaction database. As described herein, in order to improve capturing of minimal changes of the PII over time, different PII features of a transaction (e.g., edge attributes of an edge) performed between a payment account and a funding account may be converted or presented using a predefined template or natural language. Specifically, the PII features, or edge attributes, may be used to generate a sentence using the predefined template or natural language, as shown in FIG. 3E. For example, a transaction performed at time t2 between the funding account 308 and the payment account 310 may have edge attributes including, but not limited to, a name (e.g., first name and/or last name), a state code, a country, and/or a city. Using the predefined template or natural language, the transaction may be represented or converted into a sentence shown in FIG. 3E as 314. The sentence 314 may be formed as “<first name> <last name> with account number <Payment Account Number> residing in <city> and unknown state receives money from account number <Funding Account Number> at the n^{th} hour of day dd.” A plurality of transactions stored in the database may be converted into sentences as described herein. The sentences may then be used to leverage generative AI tools to construct n-dimensional vector embedding layer 316 that captures a change in context based on changes to one or more features of the PII. Each vector embedding may correspond with a sentence representing a transaction. Based on differences between the content of sentences, edges between nodes representing vectors or transactions may be distanced. The n-dimensional vector embeddings thus generated represent an edge transaction layer.

FIG. 3F is a diagram 300f showing the A2A graphical model with PII embeddings converted into a generative AI model including an n-dimensional vector with PII embeddings for another exemplary transaction stored in a transaction database. As shown in FIG. 3F, for a transaction performed between a merchant 318 and a funding account 308 at time t₂ having edge attributes including account specific information (e.g., a card type), a payment method (e.g., card present/card not present (CP/CNP), wallet, PEM, domestic/cross-border (XBR)), an amount, information about a merchant (e.g., merchant's location, past transactions performed by the merchant, merchant category code (MCC)), or a list of risk indicators (e.g., a number of chargebacks, a number of declined and/or fraud transactions), a sentence 320 may be generated using a predefined template or natural language, such as “User <user name> purchases a product worth $x at the n^{th} hour of day dd from a merchant <merchant name>; in past the user <user name> has interacted with merchant <merchant name> n times and has experienced <a number declined transactions> declines and raised chargeback worth $y, whereas the merchant has existed for last P years and has total sales volume of <sales volume amount> with total reported fraud and chargebacks worth <fraudulent and chargeback amount total>.” A plurality of transactions stored in the database may be converted into sentences as described herein. The sentences may then be used to leverage generative AI tools to construct n-dimensional vector embedding layers 322 that captures a change in the history of a merchant over time as the payment node and various funding nodes, and/or a change in the history of a funding node and various merchants as payment nodes.

FIG. 3G is a diagram 300g showing an exemplary enhanced A2A graphical model with nodes and edges including the PII embeddings. Specifically, FIG. 3G illustrates a mapping of an A2A graphical model 300g based on a plurality of transactions between one or more funding nodes and a plurality of payment accounts (or payment nodes). In FIG. 3G, a plurality of transactions at times t₀, t₁, t₂, t₃, and t₄ are shown as being performed over time between a funding account 324 and several different payment accounts including payment accounts 326, 328, and 330. In FIG. 3G, transactions at times t₀, t₁, and t₂ are between the funding account 324 and payment account 326, while transactions at times t₃ and t₄ are performed between the funding account 324 and payment account 328 and between the funding account 324 and payment account 330, respectively. While the transactions, the funding account, and the payment accounts shown in FIG. 3G are for example only, transactions occurring at different times between the payment accounts (or payment nodes) and the funding node may also be mapped to an A2A graphical model shown in FIG. 3H. The A2A graphical model shows the connections and/or transactions between various account nodes (e.g., payment nodes and/or funding nodes). As described herein, the payment node is a receiver of funds (e.g., a payee), and the funding node is a sender of funds (e.g., a payor) in a transaction. Accordingly, from the plurality of transactions that are performed at different times over a specific period, the A2A graphical model may be generated showing one or more payment nodes and one or more funding nodes associated with the plurality of transactions performed over time. In some embodiments, by way of a non-limiting example, the plurality of transactions used for generating the A2A graphical model may include transactions performed over the past 120 days or any other period of time.

FIG. 3H is a diagram 300h showing an exemplary two-stage model architecture for graphical neural network training. As shown in FIG. 3H, A2A graphical model 332 may include payment nodes, funding nodes, and transactions performed between them. The transactions included in the A2A graphical model 332 may include approved transactions (which may include legitimate and/or fraudulent transactions) and declined transactions. In FIG. 3H, the declined transactions are shown as non-existent connections. The declined transaction may include transactions declined for being suspected as fraudulent transactions and/or transactions declined for other reasons. The A2A graphical model showing approved and/or declined transactions may be generated based on the n-dimensional vector embeddings generated using generative AI, as described herein, with respect to FIG. 3E and FIG. 3F. By way of a non-limiting example, the A2A graphical model may be generated or trained in a self-supervised learning setting. During the self-supervised learning, based on the n-dimensional vector embeddings generated, as described herein, corresponding to nodes and/or edges, fraudulent nodes involved in fraudulent activities may be identified. Based on the vector embeddings associated with the declined transactions, the A2A graphical model may be fine-tuned to generate A2A graphical model 334, which includes payment nodes, funding nodes, and n-dimensional vector embeddings. In other words, the fine-tuned A2A graphical model 334 may not include declined transactions or transactions that are known to be fraudulent but may include approved transactions. The fine-tuned A2A graphical model 334 may represent a fully connected neural network layer, which is trained by applying a fraud identifying label to each fraudulent transaction of the plurality of transactions associated with a payment node associated with fraudulent activities. The fully connected layer with payment and/or funding nodes associated with n-dimensional vector embeddings may help to identify edge attributes or specific features of PII changing between transactions to identify payment nodes involved in fraudulent activities. The A2A graphical model 334 including the fully connected layer may be deployed or used to process transactions between nodes to generate embeddings for the nodes and edges, and when the n-dimensional vector embeddings indicate changes in edge attributes or significant departure for other vector embeddings for the nodes or edges, the node may be identified as a node involved in fraudulent activities. In other words, the fine-tuned A2A graphical model 334 may be applied to a subsequent transaction between a payment node and a funding node to determine if the subsequent transaction is a fraudulent transaction from the fraudulent parties involved in the transaction.

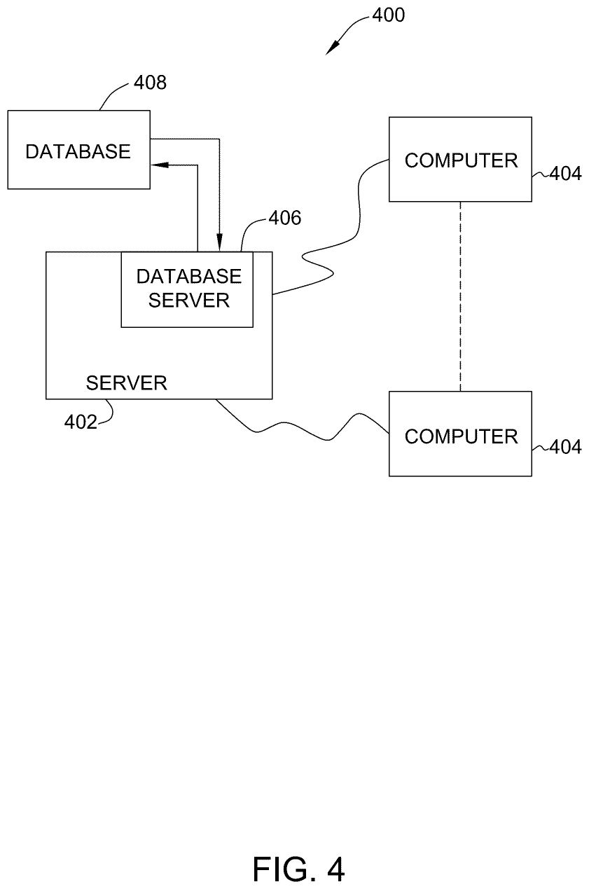

Exemplary methods and systems, as described in the present disclosure, are configured to identify bad actors and/or fraudulent transactions using a computing system and various components as shown in FIGS. 4-6.

FIG. 4 is a simplified block diagram of an example computer system 400 configured to build, train, and apply the A2A graphical model and the two-stage graphical neural network model within the payment processing network system 100 (shown in FIG. 1). In the example embodiment, system 400 includes a server system 402 and a plurality of client subsystems, also referred to as client systems 404, connected to server system 402. In one embodiment, client systems 404 are computers including a web browser, such that server system 402 is accessible to client systems 404 using the Internet. Client systems 404 are interconnected to the Internet through many interfaces including a network, such as a local area network (LAN) and/or a wide area network (WAN), dial-in connections, cable modems, wireless-connections, and special high-speed ISDN lines. Client systems 404 may be any device capable of interconnecting to the Internet including a web-based phone, personal digital assistant (PDA), or other web-connectable equipment. A database server 406 is connected to a database 408 containing information on a variety of matters, as described below in greater detail. In one embodiment, database 408 is stored on server system 402 and may be accessed by potential users at one of client systems 404 by logging onto server system 402 through one of client systems 404. In any alternative embodiment, database 408 is stored remotely from server system 402 and may be non-centralized.

As discussed below, payment card information including account numbers, payment card numbers, expiration dates, and account statuses, such as whether the account is open or closed, is stored within database 408. Further, data relating to the cardholder of a payment card may also be stored within database 408. Such cardholder data may include, for example, cardholder name and cardholder billing address. Transaction details including authorization requests and statuses for the authorization requests including authorization codes and/or reasons codes for declining the authorization requests may also be stored within database 408.

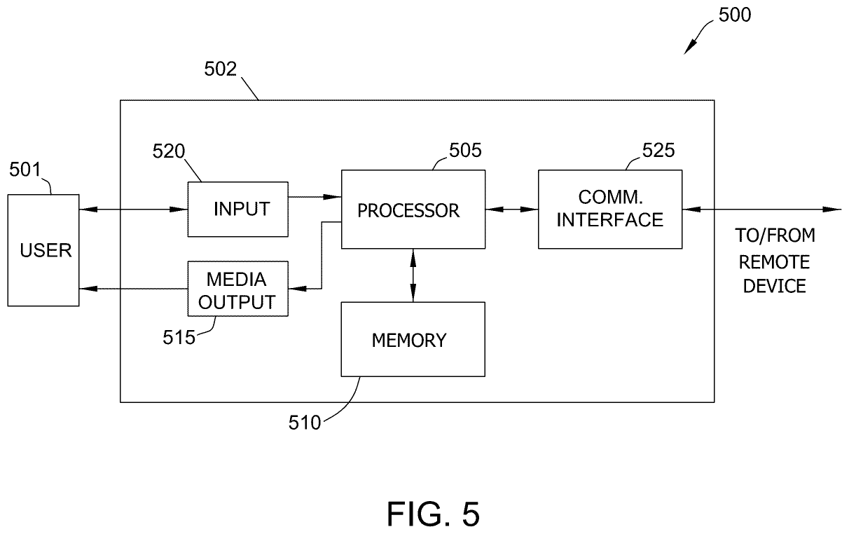

FIG. 5 illustrates an example configuration 500 of a client device or a cardholder computer device 502 operated by a user or a cardholder 501. Cardholder computer device 502 includes a processor 505 for executing instructions. In some embodiments, executable instructions are stored in a memory area 510. Processor 505 may include one or more processing units (e.g., in a multi-core configuration). Memory area 510 is any device allowing information such as executable instructions and/or other data to be stored and retrieved. Memory area 510 may include one or more computer readable media.

Cardholder computer device 502 also includes at least one media output component 515 for presenting information to cardholder 501. Media output component 515 is any component capable of conveying information to cardholder 501. In some embodiments, media output component 515 includes an output adapter such as a video adapter and/or an audio adapter. An output adapter is operatively coupled to processor 505 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, cardholder computer device 502 includes an input device 520 for receiving input from cardholder 501. Input device 520 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 515 and input device 520.

Cardholder computer device 502 may also include a communication interface 525, which is communicatively couplable to a remote device such as server system 402 or a web server operated by a merchant. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer readable instructions for providing a user interface to cardholder 501 via media output component 515 and, optionally, receiving and processing input from input device 520. A user interface may include, among other possibilities, a web browser and client application. Web browsers enable cardholders, such as cardholder 501, to display and interact with media and other information typically embedded on a web page or a website from server system 402 or a web server associated with a merchant. A client application allows cardholder 501 to interact with a server application from server system 402 or a web server associated with a merchant.

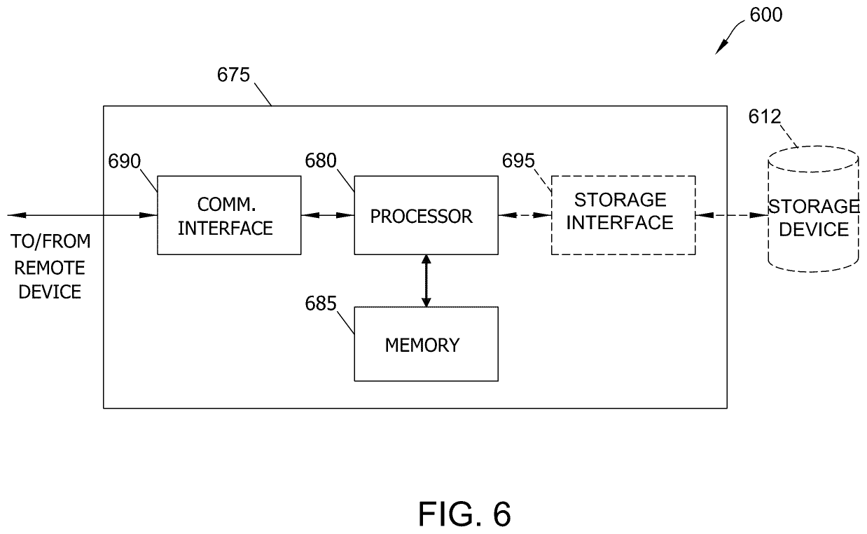

FIG. 6 illustrates an example configuration 600 of a server computer system 675 such as server system 402 (shown in FIG. 4) or interchange network 110 (shown in FIG. 1). Server computer system 675 may include, but is not limited to, database server 406.

Server computer system 675 includes a processor 680 for executing instructions. Instructions may be stored in a memory area 685, for example. Processor 680 may include one or more processing units (e.g., in a multi-core configuration).

Processor 680 is operatively coupled to a communication interface 690 such that server computer system 675 is capable of communicating with a remote device such as cardholder computer system 502 (shown in FIG. 5) or another server computer system 675. For example, communication interface 690 may receive requests from client systems 404 via the Internet, as illustrated in FIG. 4.

Processor 680 may also be operatively coupled to a storage device 612. Storage device 612 is any computer-operated hardware suitable for storing and/or retrieving data. In some embodiments, storage device 612 is integrated in server computer system 675. For example, server computer system 675 may include one or more hard disk drives as storage device 612. In other embodiments, storage device 612 is external to server computer system 675 and may be accessed by a plurality of server computer systems 675. For example, storage device 612 may include multiple storage units such as hard disks or solid-state disks in a redundant array of inexpensive disks (RAID) configuration. Storage device 612 may include a storage area network (SAN) and/or a network attached storage (NAS) system.

In some embodiments, processor 680 is operatively coupled to storage device 612 via a storage interface 695. Storage interface 695 is any component capable of providing processor 680 with access to storage device 612. Storage interface 695 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 480 with access to storage device 612.

Memory area 685 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only and are thus not limiting as to the types of memory usable for storage of a computer program.

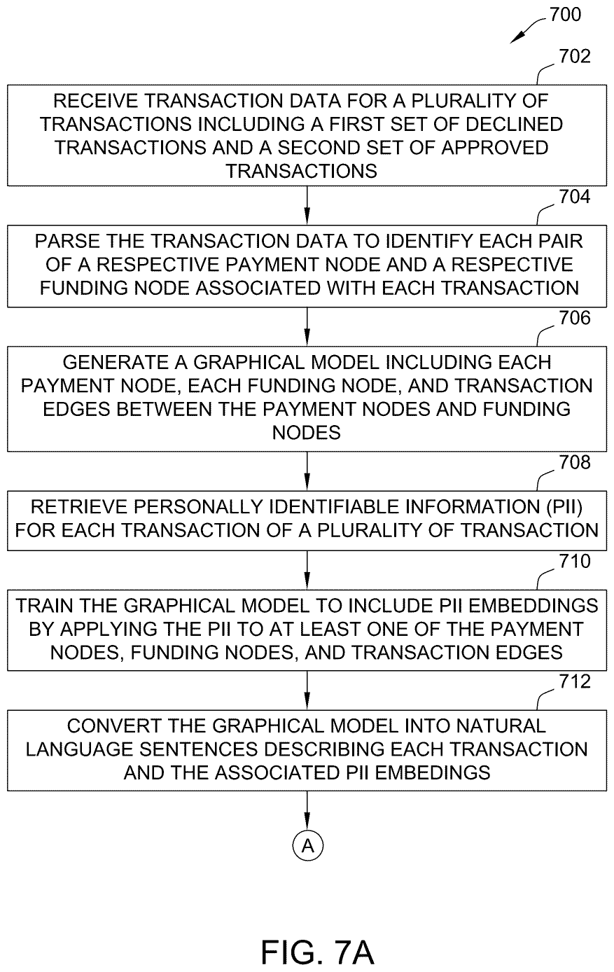

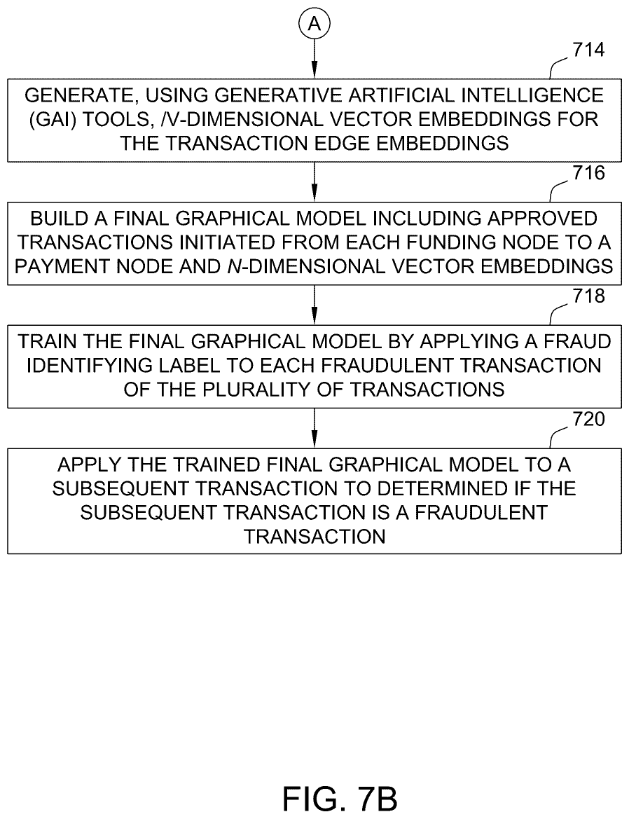

FIG. 7A and FIG. 7B illustrate a flow diagram of an example method 700 of identifying fraudulent parties and/or transactions using a graphical modeling computer system configured to build, train and apply the A2A graphical model and the two-stage graphical neural network model within the payment processing environment. In some embodiments, the method 700 may include receiving (702) transaction data for a plurality of transactions. The transaction data may be received from the payment network 110 or from the issuer 112 and/or the acquirer 104. The plurality of transactions may include a set of transactions labeled as declined transactions and another set of transactions labeled as approved transactions. As described herein, the set of declined transactions may include transactions that are declined because these transactions have been identified as fraudulent transactions by the issuer 112. Additionally, or alternatively, the transaction in the set of declined transactions may be fraudulent transactions but may have been declined for other reasons. Similarly, the set of approved transactions may include transactions which are fraudulent transactions but approved by the issuer 112.

In some embodiment, the method 700 may include parsing (704) the transaction data to identify each pair of a respective payment node and a respective funding node associated with each transaction of the plurality of transactions. As shown in FIG. 2, as described herein with respect to FIG. 2, each transaction has a corresponding pair of a payment node and a funding node. Based on the plurality of transactions, the method may include generating (706) a graphical model. The graphical model may include each payment node of a plurality of payment nodes, each funding node of a plurality of funding nodes, and transaction edges between the payment nodes and funding nodes representing the transactions occurring between the payment nodes and the funding nodes, as shown and described herein with respect to FIG. 3A.

In some embodiments, the method 700 may include retrieving (708) personally identifiable information (PII) for each transaction of the plurality of transactions. As described herein, the PII associated with each transaction of the plurality of transactions may include a first name, a last name, a city, a state, and a country, each corresponding to the payment node or the funding node. Additionally, or alternatively, the PII associated with each transaction of the plurality of transactions may include information of a merchant, wherein the information of the merchant includes at least one of: (i) account specific information, (ii) a payment method of a transaction, (iii) an amount of the transaction, (iv) a location of the merchant, (v) past transactions associated with the merchant, (vi) a category of the merchant, (vii) a number of declined transactions, and (viii) a total amount of fraudulent and/or chargeback transactions.

In some embodiments, the method 700 may include training (710) the graphical model to include PII embeddings by applying the PII to at least one of the payment nodes, the funding nodes, and/or the transaction edges, as shown and described herein with respect to FIG. 3D. The method 700 may include converting (712) the graphical model into natural language sentences describing each transaction and the associated PII embeddings. In some embodiments, and by way of a non-limiting example, the natural language sentences may be generated using a predefined template or natural language, as described herein with respect to FIG. 3E and/or FIG. 3F.

In some embodiments, the method 700 may include generating (714) n-dimensional vector embeddings for the transactional edge embeddings. Each n-dimensional vector embedding of the n-dimensional vector embeddings represents a transaction including the associated PII. Additionally, the method may include generating n-dimensional vector embeddings for the payment node embeddings or the funding node embeddings. As described herein, the n-dimensional vector embeddings may be generated using GAI tools. The n-dimensional vector embeddings may be generated as described herein with respect to FIG. 3E and/or FIG. 3F. The n-dimensional vector embeddings may represent, or may be used to identify, changing PII for the transactional edge embeddings, or n-dimensional vector embeddings may represent, or may be used to identify, changing PII for the payment node embeddings or the funding node embeddings. Further, n-dimensional vector embeddings for the transactional edge embeddings may correspond with a layer of a neural network that captures a change in the PII, and the n-dimensional vector embeddings for the payment node embeddings or the funding node embeddings may correspond with a layer of a neural network that captures an evolving history of a funding node and historical interactions of the funding with various merchants or payment nodes of the plurality of payment nodes.

In some embodiments, the method 700 may include building (716) a final graphical model including approved transactions of the plurality of transactions (e.g., the set of approved transactions of the received (702) plurality of transactions) initiated from each funding node to a corresponding payment node over a period of time and including the n-dimensional vector embeddings. The final graphical model may be trained using self-supervised learning techniques to identify declined transactions based on the n-dimensional vector embeddings and updated or fine-tuned to include a plurality of payment nodes, a plurality of funding nodes, and n-dimensional vector embeddings for the plurality of transactions associated with fund transfer. The final trained graphical model may identify changes in PII between transactions associated with a payment node of the plurality of payment nodes that indicate suspicious activity associated with the payment node, as discussed below.

In some embodiments, the method 700 may include training (718) the final graphical model by applying a fraud identifying label to each fraudulent transaction of the plurality of transaction. As described herein, each fraudulent transaction may be identified based on changes in PII between transactions associated with a transaction, or a payment node or a funding node. The trained final graphical model may be deployed and applied (720) to a subsequent transaction between a payment node of a plurality of payment nodes and a funding node of a plurality of funding nodes to determine if the subsequent transaction is a fraudulent transaction. By way of a non-limiting example, applying the trained final graphical model include generating, using the GAI tools, an n-dimensional vector embedding based on received data of the subsequent transaction and the PII corresponding to the subsequent transaction, as described herein with respect to FIG. 3E and/or FIG. 3F. The n-dimensional vector embedding associated with the received data of the subsequent transaction may be compared with the n-dimensional vector embeddings for the transactional edge embeddings corresponding to the payment node and based on an identified change in in the PII using the final graphical model, whether the subsequent transaction is a fraudulent transaction may be determined.

The computer-implemented methods discussed herein may include additional, fewer, or alternate actions, including those discussed elsewhere herein. The methods may be implemented via one or more local or remote processors, transceivers, servers, and/or sensors (such as processors, transceivers, and/or servers, and/or via computer-executable instructions stored on non-transitory computer-readable media or medium.

The embodiments described herein thus provides A2A graphical models that may be easily trained and may illustrate data in a clean condensed way, and thereby improving the graphical modeling system by requiring fewer computing resources. Further, the graphical models built and trained as described herein may also improve fraud detection with less legitimate transactions being identified as fraudulent transactions.

In some embodiments, the server 402 and/or the server 675 are configured to implement machine learning, such that the server 402 and/or the server 675 “learns” to analyze, organize, and/or process data without being explicitly programmed. Machine learning may be implemented through machine learning methods and algorithms (“ML methods and algorithms”). In an exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, item classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based on the training data, the ML module may generate a predictive function which maps outputs to inputs and may utilize the predictive function to generate ML outputs based on data inputs. The example inputs and example outputs of the training data may include any of the data inputs or ML outputs described above. In the exemplary embodiment, a processing element may be trained by providing it with a large sample of images with known characteristics or features. Such information may include, for example, information associated with a plurality of images of a plurality of different objects, items, and/or property.

In another embodiment, a ML module may employ unsupervised learning, which involves finding meaningful relationships in unorganized data. Unlike supervised learning, unsupervised learning does not involve user-initiated training based on example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based on feedback from a reward signal. Specifically, the ML module may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with voice bots or chatbots. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

Based on these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based on example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs are provided the processing element may, based on the discovered rule, accurately predict the correct output. In unsupervised machine learning, the processing element may be required to find its own structure in unlabeled example inputs. In one embodiment, machine learning techniques may be used to extract the relevant personal belonging and/or home feature information for customers from mobile device sensors, vehicle-mounted sensors, home-mounted sensors, and/or other sensor data, vehicle or home telematics data, image data, and/or other data.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include, but are not limited to, analog and digital signals, sensor data, image data, video data, patient data, and the like. ML outputs may include, but are not limited to, digital signals, medical diagnoses, segmented images, health care predictions and guidance, and the like. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

This written description uses examples to illustrate the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A graphical modeling computer system comprising a memory, generative artificial intelligence (GAI) tools, and a processor in communication with the memory and the GAI tools, the processor configured to:
receive transaction data for a plurality of transactions including a set of declined transactions and a set of approved transactions;
parse the transaction data to identify each pair of a respective payment node and a respective funding node associated with each transaction of the plurality of transactions;
generate a graphical model including each payment node of a plurality of payment nodes, each funding node of a plurality of funding nodes, and transaction edges between the payment nodes and funding nodes representing the transactions occurring between the payment nodes and the funding nodes;
retrieve personally identifiable information (PII) for each transaction of the plurality of transactions;
train the graphical model to include PII embeddings by applying the PII to at least one of the payment nodes, the funding nodes, and the transaction edges;
convert the graphical model into natural language sentences describing each transaction and the associated PII embeddings;
generate, using the GAI tools, n-dimensional vector embeddings based on natural language sentences, each n-dimensional vector embedding representing a transaction including the associated PII;
build a final graphical model including approved transactions of the plurality of transactions initiated from each funding node to a corresponding payment node over a period of time and including the n-dimensional vector embeddings;
train the final graphical model by applying a fraud identifying label to each fraudulent transaction of the plurality of transactions; and
apply the trained final graphical model to a subsequent transaction between a payment node of the plurality of payment nodes and a funding node of the plurality of funding nodes to determine if the subsequent transaction is a fraudulent transaction.

2. The graphical modeling computer system of claim 1, wherein the processor is further configured to:
generate, using the GAI tools, n-dimensional vector embeddings for the payment node or the funding node;
based on the n-dimensional vector embeddings for the transactional edge, payment node, or the funding node, train the final graphical model using self-supervised learning techniques to identify declined transactions; and
update the final graphical model that is fine tuned to include a plurality of payment nodes, a plurality of funding nodes, and n-dimensional vector embeddings for the plurality of transactions associated with fund transfer.

3. The graphical modeling computer system of claim 1, wherein the processor is further configured to convert the graphical model into natural language sentences describing each transaction and the associated PII embeddings using a predefined template.

4. The graphical modeling computer system of claim 1, wherein the processor is further configured to convert the graphical model into natural language sentences describing each transaction and the associated PII embeddings using natural language.

5. The graphical modeling computer system of claim 1, wherein the PII associated with each transaction of the plurality of transactions includes a first name, a last name, a city, a state, and a country, each corresponding to the payment node or the funding node.

6. The graphical modeling computer system of claim 1, wherein the n-dimensional vector embeddings represent changing PII for the transactional edge or the n-dimensional vector embeddings represent changing PII for the payment node or the funding node correspond with a layer of a neural network that captures a change in the PII.

7. The graphical modeling computer system of claim 1, wherein the PII associated with each transaction of the plurality of transactions includes information of a merchant, wherein the information of the merchant includes at least one of: (i) account specific information, (ii) a payment method of a transaction, (iii) an amount of the transaction, (iv) a location of the merchant, (v) past transactions associated with the merchant, (vi) a category of the merchant, (vii) a number of declined transactions, and (viii) a total amount of fraudulent and/or chargeback transactions.

8. The graphical modeling computer system of claim 1, wherein the n-dimensional vector embeddings represent changing PII for the transactional edge or the n-dimensional vector embeddings represent changing PII for the payment node or the funding node correspond with a layer of a neural network that captures an evolving history of a funding node and historical interactions of the funding with various payment nodes of the plurality of payment nodes.

9. The graphical modeling computer system of claim 1, wherein the processor is further configured to:
generate, using the GAI tools, an n-dimensional vector embedding based on received data of the subsequent transaction and PII corresponding to the subsequent transaction; and
based on a comparison of the n-dimensional vector embedding for the subsequent transaction with the n-dimensional vector embeddings for the transactional edge corresponding to the payment node and an identified change in the PII using the final graphical model, determine whether the subsequent transaction is a fraudulent transaction.

10. A computer-implemented method performed by a graphical modeling computer system comprising at least one memory, generative artificial intelligence (GAI) tools, and at least one processor in communication with the at least one memory and the GAI tools, the method comprising:
receiving transaction data for a plurality of transactions including a set of declined transactions and a set of approved transactions;
parsing the transaction data to identify each pair of a respective payment node and a respective funding node associated with each transaction of the plurality of transactions;
generating a graphical model including each payment node of a plurality of payment nodes, each funding node of a plurality of funding nodes, and transaction edges between the payment nodes and funding nodes representing the transactions occurring between the payment nodes and the funding nodes;
retrieving personally identifiable information (PII) for each transaction of the plurality of transactions;
training the graphical model to include PII embeddings by applying the PII to at least one of the payment nodes, the funding nodes, and the transaction edges;
converting the graphical model into natural language sentences describing each transaction and the associated PII embeddings;
generating, using the GAI tools, n-dimensional vector embeddings based on the natural language sentences, each n-dimensional vector embedding representing a transaction including the associated PII;
building a final graphical model including approved transactions of the plurality of transactions initiated from each funding node to a corresponding payment node over a period of time and including the n-dimensional vector embeddings;
training the final graphical model by applying a fraud identifying label to each fraudulent transaction of the plurality of transactions; and
applying the trained final graphical model to a subsequent transaction between a payment node of the plurality of payment nodes and a funding node of the plurality of funding nodes to determine if the subsequent transaction is a fraudulent transaction.

11. The computer-implemented method of claim 10, further comprising:
generating, using the GAI tools, n-dimensional vector embeddings for the payment node or the funding node;
based on the n-dimensional vector embeddings for the transactional edge, payment node, or the funding node, training the final graphical model using self-supervised learning techniques to identify declined transactions; and
updating the final graphical model that is fine tuned to include a plurality of payment nodes, a plurality of funding nodes, and n-dimensional vector embeddings for the plurality of transactions associated with fund transfer.

12. The computer-implemented method of claim 10, further comprising converting the graphical model into natural language sentences describing each transaction and the associated PII embeddings using a predefined template.

13. The computer-implemented method of claim 10, further comprising converting the graphical model into natural language sentences describing each transaction and the associated PII embeddings using natural language.

14. The computer-implemented method of claim 10, wherein the PII associated with each transaction of the plurality of transactions includes a first name, a last name, a city, a state, and a country, each corresponding to the payment node or the funding node.

15. The computer-implemented method of claim 10, wherein the n-dimensional vector embeddings represent changing PII for the transactional edge or the n-dimensional vector embeddings represent changing PII for the payment node or the funding node correspond with a layer of a neural network that captures a change in the PII.

16. The computer-implemented method of claim 10, wherein the PII associated with each transaction of the plurality of transactions includes information of a merchant, wherein the information of the merchant includes at least one of: (i) account specific information, (ii) a payment method of a transaction, (iii) an amount of the transaction, (iv) a location of the merchant, (v) past transactions associated with the merchant, (vi) a category of the merchant, (vii) a number of declined transactions, and (viii) a total amount of fraudulent and/or chargeback transactions.

17. The computer-implemented method of claim 10, wherein the n-dimensional vector embeddings represent changing PII for the transactional edge or the n-dimensional vector embeddings represent changing PII for the payment node or the funding node correspond with a layer of a neural network that captures an evolving history of a funding node and historical interactions of the funding with various payment nodes of the plurality of payment nodes.

18. The computer-implemented method of claim 10, further comprising:
generating, using the GAI tools, an n-dimensional vector embedding based on received data of the subsequent transaction and PII corresponding to the subsequent transaction; and
based on the comparison of the n-dimensional vector embedding for the subsequent transaction with the n-dimensional vector embeddings for the transactional edge corresponding to the payment node and an identified change in the PII using the final graphical model, determining whether the subsequent transaction is a fraudulent transaction.

19. At least one non-transitory computer-readable media having machine-executable instructions stored thereon, which when executed by at least one processor of a graphical modeling computer system in communication with at least one memory and generative artificial intelligence (GAI) tools of the graphical modeling computer system, cause the at least one processor to:
receive transaction data for a plurality of transactions including a set of declined transactions and a set of approved transactions;
parse the transaction data to identify each pair of a respective payment node and a respective funding node associated with each transaction of the plurality of transactions;
generate a graphical model including each payment node of a plurality of payment nodes, each funding node of a plurality of funding nodes, and transaction edges between the payment nodes and funding nodes representing the transactions occurring between the payment nodes and the funding nodes;
retrieve personally identifiable information (PII) for each transaction of the plurality of transactions;
train the graphical model to include PII embeddings by applying the PII to at least one of the payment nodes, the funding nodes, and the transaction edges;
convert the graphical model into natural language sentences describing each transaction and the associated PII embeddings;
generate, using the GAI tools, n-dimensional vector embeddings based on the natural language sentences, each n-dimensional vector embedding representing a transaction including the associated PII;
build a final graphical model including approved transactions of the plurality of transactions initiated from each funding node to a corresponding payment node over a period of time and including the n-dimensional vector embeddings;
train the final graphical model by applying a fraud identifying label to each fraudulent transaction of the plurality of transactions; and
apply the trained final graphical model to a subsequent transaction between a payment node of the plurality of payment nodes and a funding node of the plurality of funding nodes to determine if the subsequent transaction is a fraudulent transaction.

20. The at least one non-transitory computer-readable media of claim 19, wherein the instructions, when executed by the at least one processor of the graphical modeling computer system, cause the at least one processor to:
generate, using the GAI tools, n-dimensional vector embeddings for the payment node or the funding node;
based on the n-dimensional vector embeddings for the transactional edge, payment node, or the funding node, train the final graphical model using self-supervised learning techniques to identify declined transactions; and
update the final graphical model that is fine tuned to include a plurality of payment nodes, a plurality of funding nodes, and n-dimensional vector embeddings for the plurality of transactions associated with fund transfer.
